(19) United States
(12) Patent Application Publication
(10) Pub. No.: US 2025/0313165 A1
(43) Pub. Date: Oct. 9, 2025

(54) DAMPING MATERIAL FOR FLOOR AND VIBRATION CONTROL METHOD

(71) Applicant: INOAC CORPORATION, Nagoya-shi, Aichi-ken (JP)

(72) Inventors: Kazuya SASAZAWA, Hadano-shi (JP); Hiroki SUGIMOTO, Toyota-shi (JP); Katsuhiro TANGE, Inazawa-shi (JP)

(73) Assignee: INOAC CORPORATION, Nagoya-shi, Aichi-ken (JP)

(21) Appl. No.: 18/863,079

(22) PCT Filed: Jun. 6, 2023
(86) PCT No.: PCT/JP2023/021069

§ 371 Date: Nov. 5, 2024

(30) Foreign Application Priority Data
Jun. 28, 2022 (JP) 2022-103807

(51) Int. Cl. B60R 13/08; G10K 11/168

(52) U.S. Cl. CPC B60R 13/083; G10K 11/168

(57) ABSTRACT

A damping material for floor includes a polyurethane foam layer, wherein the polyurethane foam layer has a 25% compressive hardness from 10 kPa to 30 kPa, inclusive.

### TECHNICAL FIELD

The present disclosure relates to a damping material for floor and a vibration control method.

### BACKGROUND ART

Conventionally, various floor materials have been developed (refer to, for example, Patent Document 1).

### RELATED ART DOCUMENTS

### Patent Documents

Patent Document 1: JP H09-95169 (paragraph [0006], and FIG. 1, for example)

### SUMMARY OF THE INVENTION

### Problems Solved by the Invention

Conventional floor materials have been required to have a vibration damping function.

### Means for Solving the Problems

A first aspect of the invention is a damping material for floor including a polyurethane foam layer.

### BRIEF DESCRIPTION OF THE DRAWINGS

FIG. 1A is a side view of a damping material for floor provided in a vehicle, and FIG. 1B is a sectional side view of the damping material for floor placed on a floor panel.

FIG. 2A is a cross-sectional view of a mold into which a raw material of the damping material for floor is injected, FIG. 2B is a cross-sectional view of the mold closed, and FIG. 2C is a cross-sectional view of a polyurethane foam layer foamed and molded integrally with a fiber layer in the mold.

FIG. 3 is a cross-sectional view of a test instrument for a damping property test.

FIG. 4A is a table representing characteristics of the examples and the comparative examples, and FIG. 4B is a graph representing stress-strain curves of Examples 2, 4, and 6 and Comparative Example 1.

FIG. 5 is a graph representing stress-strain curves up to a compressive strain of 3% in some of the examples.

FIG. 6A is a graph representing resonance frequency and vibration transmissibility in one of the examples and the comparative examples, and FIG. 6B is a graph representing resonance frequency and vibration transmissibility in some of the examples using the damping material for floor including the polyurethane foam layer.

### MODE FOR CARRYING OUT THE INVENTION

### First Embodiment

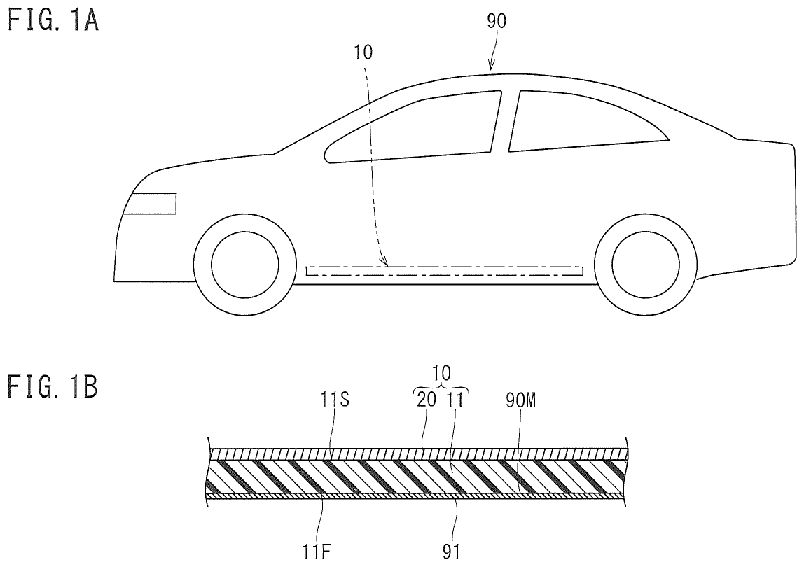

As illustrated in FIGS. 1A and 1B, a damping material 10 for floor according to a first embodiment of the present disclosure is used in an automobile 90 and placed on a floor surface 90M (that is, an upper surface of a floor panel 91) of a vehicle body. For example, the damping material 10 for floor is used as a soundproofing material having a function of sound insulation and sound absorption or a level raising material, and includes a polyurethane foam layer 11. For example, a fiber layer 20, such as a floor carpet, is laid over the polyurethane foam layer 11. For example, when the upper surface of the floor panel 91 has an uneven shape, the damping material 10 for floor is formed to have an uneven shape corresponding to the uneven shape in the floor panel 91.

As illustrated in FIG. 1B, the damping material 10 for floor of the present embodiment is formed in a sheet shape and has a two-layer structure including the polyurethane foam layer 11 and the fiber layer 20 laminated on the polyurethane foam layer 11.

The polyurethane foam layer 11 may be made of molded urethane obtained by molding (foaming in a mold) or slab urethane obtained by slab forming (foaming on an open continuous line). The damping material 10 for floor is required to have a certain degree of rigidity and hardness so as not to sink excessively when stepped on by an occupant. Therefore, the polyurethane foam layer 11 is preferably molded urethane. Since the molded urethane is foamed and molded in a mold, the apparent density can be increased. In the molded urethane, a skin layer is formed on a surface portion that is in contact with the molding surface of the mold. Therefore, a polyurethane foam having excellent hardness and durability can be produced by molding. The skin layer is a surface layer whose apparent density is higher than that of an inner portion of the polyurethane foam layer 11.

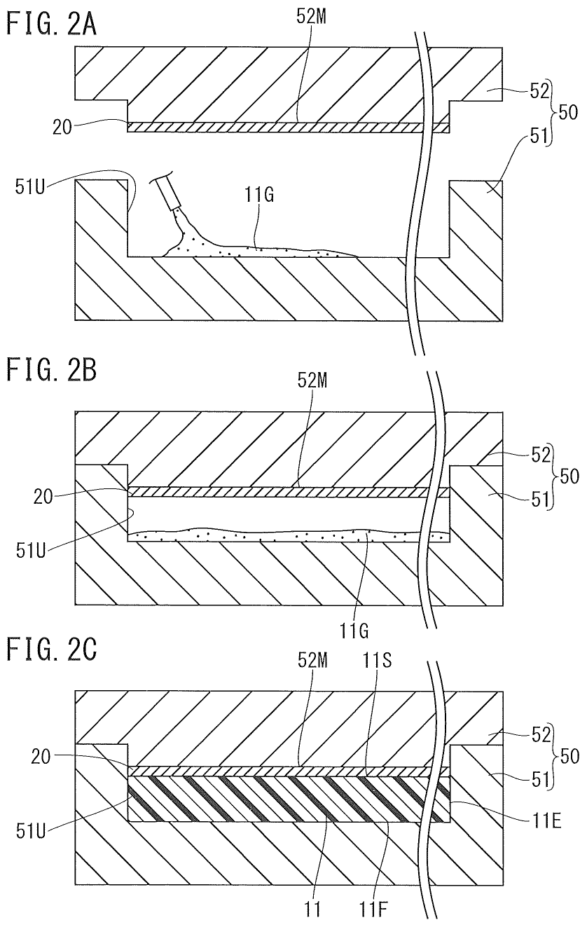

In the example of the present embodiment, the polyurethane foam layer 11 is made of molded urethane and has a skin layer. On one of front and back surfaces of the polyurethane foam layer 11, the skin layer is formed as a surface layer of a first surface 11F that is opposite to the fiber layer 20, and is also formed as a surface layer of an outer peripheral surface 11E (refer to FIG. 2C) connecting the front surface and the back surface. In particular, the skin layer of the outer peripheral surface 11E can improve rigidity in the thickness direction of the polyurethane foam layer 11. When the polyurethane foam layer 11 and the fiber layer 20 are separately formed, a skin layer may be provided on the fiber layer 20 side of the polyurethane foam layer 11.

The polyurethane foam layer 11 may have air permeability (for example, an open-cell structure) or may have air impermeability (for example, a closed-cell structure). When the polyurethane foam layer 11 has air permeability, the entire damping material 10 for floor can be imparted with air permeability, and sound absorbency can be improved. In an example of the present embodiment, the polyurethane foam layer 11 has air permeability and also the skin layer has air permeability. As a result, both rigidity and sound absorbency can be improved in the polyurethane foam layer 11.

The cell membranes (what is called mirror) between foam cells in a foamed body can be removed by, for example, blast of combustion gas or hydrolysis by alkali, but it is desirable that the cell membranes are left without being removed. As compared with the case where there is no cell membrane, the damping property of the foamed body can be better when there is the cell membrane.

The apparent density of the polyurethane foam layer 11 is, for example, preferably 40 kg/m³ or more, and more preferably 45 kg/m³ or more from the viewpoint of the above-described rigidity, hardness, and the like. The apparent density of the polyurethane foam layer 11 is, for example, preferably 80 kg/m³ or less, and more preferably 75 kg/m³ or less from the viewpoint of weight reduction. As described above, by reducing the weight of the polyurethane foam layer 11, for example, when the damping material 10 for floor is mounted on a vehicle such as the automobile 90, it is possible to improve the fuel efficiency and electric efficiency of the vehicle.

The fiber layer 20 described above is integrated with an upper surface (second surface 11S) of the polyurethane foam layer 11. The fiber layer 20 is made of, for example, a fiber sheet such as a nonwoven fabric. In the example of the present embodiment, the damping material 10 for floor is an integrally molded product obtained by foaming and molding the polyurethane foam layer 11 integrally with the fiber layer 20. For example, an impregnation layer that is impregnated with a raw material of the polyurethane foam layer 11 and is cured may be formed in at least a portion of the fiber layer 20 facing the polyurethane foam layer 11. In the example of the present embodiment, the entire fiber layer 20 including the impregnation layer has air permeability.

Fibers constituting the fiber layer 20 may be synthetic fibers or natural fibers. Examples of such fibers include polyethylene terephthalate (PET) fibers, polyester fibers, polypropylene fibers, polyamide fibers, acrylic fibers, vinylon fibers, polyurethane fibers (SPANDEX), glass fibers, carbon fibers, and ZYLON (registered trademark). Examples of the natural fibers include wool, cotton, and cellulose nanofibers. The form of the fiber layer 20 is not limited to a nonwoven fabric, and may be a woven fabric, a knitted fabric, and the like. Examples of the nonwoven fabric include a spunlace nonwoven fabric, a spunbonded nonwoven fabric, and a needle punch nonwoven fabric.

Now, damping property is required for floor materials used for floors of vehicles, buildings, and the like from the viewpoint of improving quietness or the like. Therefore, damping property is also required for conventional floor materials such as floor materials to be placed on the floor panel 91 or the like. For this purpose, since the damping material 10 for floor of the present embodiment has the polyurethane foam layer 11, it is possible to improve the damping property as compared with a floor material having only a fiber layer. Here, in order to further improve the damping property, the inventor of the present application investigated the relationship between the damping property and the characteristics of the foamed body. As a result of intensive studies, the present inventor found that it is possible to further improve the damping property by focusing on the elastic modulus of the foamed body, thereby leading to the invention of the damping material 10 for floor of the present disclosure.

Specifically, for the damping material 10 for floor, the average elastic modulus of the polyurethane foam layer 11 in a compressive strain range of 0 to 3% (range of compressive strain between 0 and 0.03, inclusive) is preferably 400 kPa or less. With this configuration, as described later, it is possible to remarkably improve the damping property. Here, the average elastic modulus in the compressive strain range of 0 to 3% is obtained as a slope of an approximate straight line in a range where the strain is from 0% to 3%, inclusive, with respect to a stress-strain curve when the polyurethane foam layer 11 is compressively deformed. The approximate straight line and the slope thereof are calculated by a least squares method and can be obtained, for example, by spreadsheet software “Microsoft Excel” (manufactured by Microsoft Corporation).

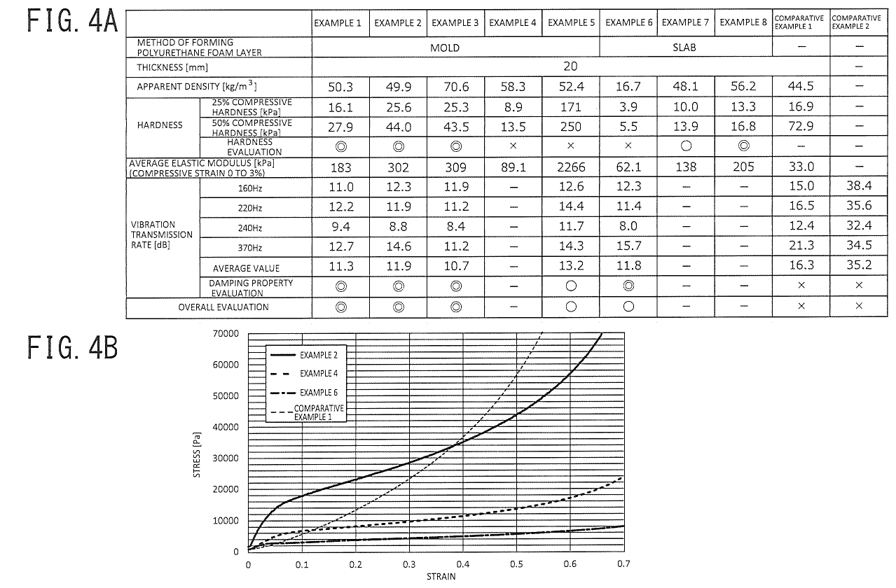

In the polyurethane foam layer 11, in the stress-strain curve, the compressive strain corresponding to the proportional limit (the limit at which the stress increases linearly with respect to the increase in strain) is 3% (0.03) or more (that is, at least in the compressive strain range of 0 to 3% that is equal to or less than the proportional limit compressive strain, the stress increases linearly with respect to the increase in the compressive strain; refer to, for example, FIG. 4B).

Here, when the average elastic modulus of the polyurethane foam layer 11 decreases, it is conceivable that the above-described rigidity and hardness decrease. Therefore, the average elastic modulus of the polyurethane foam layer 11 is preferably 170 kPa or more.

As described later, the damping material 10 for floor can remarkably suppress vibration of, for example, 100 to 400 Hz. Therefore, according to the method for controlling vibration with the damping material 10 for floor placed on the floor surface 90M of the vehicle body, the vibration of the floor panel 91 at 100 to 400 Hz in particular can be suppressed. The damping material 10 for floor configured to control vibrations at 100 to 400 Hz and the method for controlling vibrations at 100 to 400 Hz using the damping material 10 for floor mentioned above have not been exist so far, and are possible to achieve a remarkable effect that cannot be predicted from the technical level of the prior art.

The damping material 10 for floor may be used in a gasoline vehicle or an electric vehicle. In the latter case, since there is no noise from an engine, the sound due to the vibration of the floor panel 91 may become conspicuous. However, by using the damping material 10 for floor in an electric vehicle, the vibration of the floor panel 91 can be effectively suppressed, and the quietness can be particularly improved.

The damping material 10 for floor of the present embodiment is manufactured, for example, as follows. First, a raw material 11G of the polyurethane foam layer 11 (refer to FIG. 2A) and a fiber sheet as the fiber layer 20 are prepared. Specifically, as the raw material 11G, a raw material containing a polyol component, a polyisocyanate component, a foaming agent, a catalyst, and the like is prepared.

In FIG. 2A, a mold 50 for foaming the polyurethane foam layer 11 is illustrated. The mold 50 includes a lower mold 51 and an upper mold 52. Then, in a mold open state where the lower mold 51 and the upper mold 52 are separated from each other, a fiber sheet as the fiber layer 20 is set on a molding surface 52M on the upper mold 52. The molding surface of the lower mold 51 is provided with a molding recess portion 51U serving as a cavity for foaming the polyurethane foam layer 11. Then, the raw material 11G is injected into the molding recess portion 51U, and the lower mold 51 and the upper mold 52 are joined to close the mold 50 (refer to FIG. 2B).

Then, as illustrated in FIG. 2C, the raw material 11G is foamed and cured in the cavity of the closed mold 50, whereby the polyurethane foam layer 11 integrated with the fiber layer 20 is foamed and molded. For example, at this time, the fiber layer 20 is impregnated with the raw material 11G and cured to form the impregnation layer.

By being molded in this manner, a skin layer is formed on a surface portion of the polyurethane foam layer 11 excluding the second surface 11S that is integrated with the fiber layer 20. When the skin layer has air permeability, gas produced during molding can be easily released to the outside.

The skin layer having air permeability can be easily formed by using a linear hydrocarbon wax as a mold release agent for the mold 50. The mold release agent is applied to the molding surface of the mold 50 before the raw material 11G is injected.

Examples of the linear hydrocarbon wax include paraffin wax, Fischer-Tropsch wax, and sasol wax, and for example, a solvent-based mold release agent in which the linear hydrocarbon wax is dispersed in an organic solvent, a water-based mold release agent in which the linear hydrocarbon wax is dispersed in water using an emulsifier, and the like can be used. In order to form the skin layer, a branched hydrocarbon wax can also be used as a mold release agent. Examples of the branched hydrocarbon wax include microcrystalline wax, modified polyethylene wax, and the like, and for example, a solvent-based mold release agent, a water-based mold release agent, and the like can be used.

When the polyurethane foam layer 11 integrated with the fiber layer 20 is removed from the mold 50 illustrated in FIG. 2C, the damping material 10 for floor is obtained. When the polyurethane foam layer 11 is obtained by slab forming, for example, the damping material 10 for floor can be obtained by bonding the fiber layer 20 to the polyurethane foam layer 11.

### Other Embodiments

In the above embodiment, the polyurethane foam layer 11 and the fiber layer 20 are integrally formed, but only the polyurethane foam layer 11 may be molded, and a fiber layer such as a carpet may be placed on the polyurethane foam layer 11.

In the above embodiment, the damping material 10 for floor is used in the automobile 90, but for example, may be used in a vehicle such as a railway vehicle or a ship and placed on a floor surface of the vehicle. The damping material 10 for floor may be used in a building, and may be placed on, for example, a floor surface of the building.

In the above embodiment, the damping material 10 for floor is placed on the floor surface, but may be applied to a floor material from below.

In the above embodiment, the skin layer of the polyurethane foam layer 11 is provided on the first surface 11F side out of the front and back surfaces of the polyurethane foam layer 11, but may be provided on the second surface 11S side that is opposite to the first surface 11F. In this case, for example, after the polyurethane foam layer 11 having the skin layers on both the front and back sides is foamed and molded in the mold 50, the fiber layer 20 is bonded with an adhesive, or the like, to or is placed on the polyurethane foam layer 11, whereby the damping material 10 for floor can be obtained. The skin layer of the polyurethane foam layer 11 obtained by molding can be appropriately sliced to be cut off. The polyurethane foam layer 11 may have a structure in which at least one of the first surface 11F, the second surface 11S, or the outer peripheral surface 11E is not provided with the skin layer.

In the above embodiment, the damping material 10 for floor has a two-layer structure, but may have a laminated structure with three or more layers. For example, the fiber layer 20 may have a laminated structure, and may include, for example, a plurality of stacked fiber sheets. Another layer may be laminated between the polyurethane foam layer 11 and the fiber layer 20, or another layer may be provided under the polyurethane foam layer 11 or on the fiber layer 20. Further, the damping material 10 for floor can be formed in a single-layer structure of the polyurethane foam layer 11.

In the above embodiment, instead of the polyurethane foam layer 11 of the damping material 10 for floor, for example, a foam layer of a polyolefin resin such as a polyethylene foam or a polypropylene foam, or a foam layer of a phenol resin can be provided.

In the above embodiment, a surface layer containing no fiber can be provided instead of the fiber layer 20. Examples of such a surface layer include a surface layer formed of an air-permeable or air-impermeable resin sheet.

### EXAMPLES

Hereinafter, the above embodiment will be described more specifically with reference to the examples and the comparative examples, but the damping material for floor of the present disclosure is not limited to the following examples.

### 1. Configurations of Examples and Comparative Examples

Examples 1 to 8 and Comparative Examples 1 and 2 illustrated in FIG. 4A were evaluated. The materials of the damping materials for floor are different from each other. In Example 1 to 8, the apparent density, hardness, and average elastic modulus in FIG. 4A were measured in a state where only the polyurethane foam layer 11 was prepared.

### Examples 1 to 5

The damping material 10 for floor according to each of Examples 1 to 5 is a single polyurethane foam layer 11 obtained by molding, in which a skin layer is formed on the first surface 11F, the second surface 11S that is opposite to the first surface 11F, and the outer peripheral surface 11E. The damping material 10 for floor has air permeability.

### Examples 6 to 8

The damping material for floor according to each of Examples 6 to 8 is a polyurethane foam layer 11 obtained by slab forming, and a skin layer is not formed on this polyurethane foam layer 11.

### Comparative Example 1

Comparative Example 1 is a miscellaneous felt (recycled fiber product).

### Comparative Example 2

Comparative Example 2 is a blank without a damping material for floor.

### 2. Evaluation

Properties including a damping property and others of the examples and the comparative examples were evaluated (refer to FIG. 4A). The evaluation methods for the respective properties of the examples and the comparative examples are described below.

### Evaluation Method

### (1) Apparent Density

The density of the damping material for floor was measured in accordance with JIS K7222.

### (2) Average Elastic Modulus

The measurement samples of Examples 1 to 8 and Comparative Example 1 were compressed at 23° C. using Autograph AG-X/R (manufactured by Shimadzu Corporation), and the average elastic modulus in the compressive strain range of 0 to 3% was obtained for each measurement sample. In Examples 1 to 8, only the polyurethane foam layer 11 was used as a measurement sample. The size of each measurement sample is 100 mm×100 mm×20 mm (thickness). Then, a pressurizer (a pressing surface of which has a circular shape with a diameter of 50 mm) was applied to the central portion of the planar shape of the measurement sample, and the measurement sample was compressed at a speed of 50 mm/min until the compressive strain of the measurement sample reached 70% (until the thickness reached 30% of the original thickness) to obtain a stress-strain curve. In addition, an approximate straight line in a range where the compressive strain was from 0% to 3%, inclusive, with respect to the stress-strain curve was obtained using spreadsheet software “Microsoft Excel” (manufactured by Microsoft Corporation), and the slope of the approximate straight line was calculated (the y-axis intercept was not fixed). The stress data on the stress-strain curve were plotted every 0.01 seconds from the start of pressurization until the strain reaches 3%.

### (3) Hardness

Regarding the hardness of the damping material for floor, in the compression test for calculating the average elastic modulus, the stress received by the pressurizer when the compressive strain of the measurement sample reached 25% was defined as 25% compressive hardness, and the stress received by the pressurizer when the compressive strain of the measurement sample reached 50% was defined as 50% compressive hardness.

Here, assuming that the weight of a person standing on the damping material for floor is 65 kg and the area of both feet is 0.05 m², a stress of 12.740 kPa (1300 kg/m²) is applied to the damping material for floor when the person stands on the damping material for floor. If the polyurethane foam layer 11 is compressed by 25% or more and sinks when receiving such a stress, the polyurethane foam layer 11 is considered to be not suitable as a damping material for floor. Therefore, in particular, the 25% compressive hardness of the polyurethane foam layer 11 is preferably 13 kPa or more. When the damping material for floor is too hard, a cushioning property and the like are not suitable, and therefore the 25% compressive hardness of the polyurethane foam layer 11 is preferably 30 kPa or less. From such a viewpoint, in the evaluation of the hardness, the case where the 25% compressive hardness of the polyurethane foam layer 11 was from 13 kPa to 30 kPa, inclusive, was evaluated as “⊚”, the case where the 25% compressive hardness was 10 kPa or more and less than 13 kPa was evaluated as “o”, and the case where the 25% compressive hardness was less than 10 kPa or greater than 30 kPa was evaluated as “x”.

### (4) Damping Property

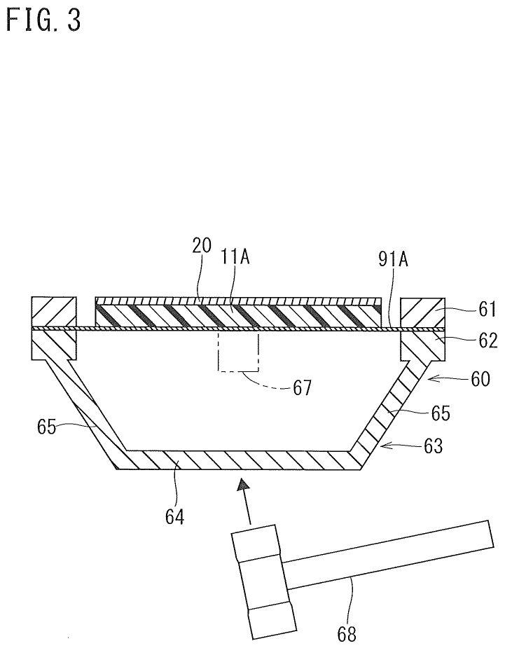

The damping properties of the examples and the comparative examples were compared with one another. A test instrument for evaluating the damping property is illustrated in FIG. 3. In this test instrument, an evaluation sample 11A (polyurethane foam layer 11 in Examples 1 to 8, miscellaneous felt in Comparative Example 1) is fixed on a steel plate 91A as the floor panel 91, and vibration is applied to the steel plate 91A, thereby evaluating the damping property of the evaluation sample 11A. Specifically, this test instrument includes a frame unit 60 that fixes the outer edge portion of the steel plate 91A. The frame unit 60 includes an upper frame 61 and a lower frame 62 that are screwed together in a state of vertically sandwiching the outer edge portion of the steel plate 91A, and further includes a base portion 63 that supports the lower frame 62 from below. In the base portion 63, a side wall portion 65 is erected upward from an outer edge portion of a bottom portion 64 having a plate shape, and the lower frame 62 is fixed to the upper end of the side wall portion 65 (for example, formed integrally with the lower frame 62). In addition, the frame unit 60 is supported at its four corners by springs suspended from a supporting portion, which is not illustrated. An acceleration sensor 67 is attached to a central portion of the lower surface of the steel plate 91A. The frequency of the vibration of the springs is much lower than the frequency of a resonance peak to be described later.

The evaluation sample 11A for each of the examples and the comparative example is placed on the steel plate 91A, and the fiber layer 20 is further laminated on the evaluation sample 11A. The planar size of the evaluation sample 11A is 500 mm×400 mm, and the thickness is 20 mm. The steel plate 91A has a size of 600 mm×500 mm×0.8 mm (thickness), and the fiber layer 20 is a nonwoven fabric having a size of 500 mm×400 mm×1.0 mm (thickness) and a basis weight of 1600 g/m². The steel plate 91A, the damping material for floor, and the fiber layer 20 are disposed to have the same longitudinal direction.

Then, as described above, in a state where the steel plate 91A is fixed to the frame unit 60, the central portion of the bottom portion 64 of the base portion 63 is hit from below by an impulse hammer 68, and vibration is applied to the steel plate 91A through the frame unit 60. The vibration of the frame unit 60 when the bottom portion 64 is hit by the impulse hammer 68 is negligible vibration as compared with the vibration of the steel plate 91A.

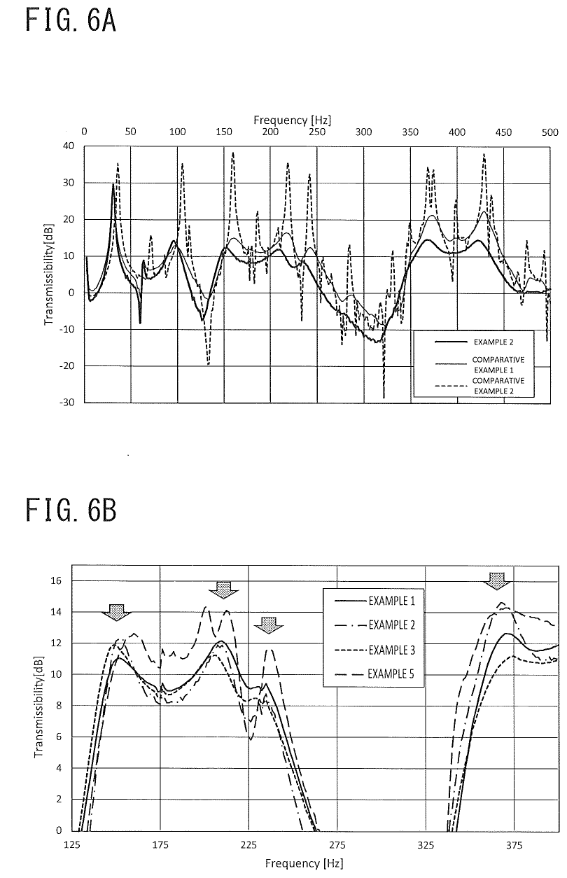

The impulse hammer 68 and the acceleration sensor 67 are connected to an FFT analyzer. The vibration transmissibility [dB] for each frequency was obtained from the vibration application force of the impulse hammer 68 and the detection results of the acceleration sensor 67 (refer to FIGS. 6A and 6B), and among the resonance peaks obtained, the vibration transmissibility (height of resonance peak) was evaluated for the four resonance peaks (peaks around 160 Hz, around 220 Hz, around 240 Hz, and around 370 Hz designated with arrows in FIG. 6B) observed around the range of 125 to 400 Hz that are considered to be particularly contributing to road noise.

The damping property was evaluated as “⊚” when the average value of the vibration transmissibility at the four peaks was 13 dB or less, “o” when the average value was more than 13 dB and 16 dB or less, and “x” when the average value was more than 16 dB. Note that the lower the vibration transmissibility, the better the damping property.

### (5) Overall Evaluation

When both the evaluation of the damping property and the evaluation of the hardness were “o” or higher, the overall evaluation was considered “⊚”. When the evaluation of the damping property was “o” or higher but the evaluation of the hardness was “x”, the overall evaluation was considered “o”. When the evaluation of the damping property was “x”, the overall evaluation was considered “x”.

### Evaluation Results

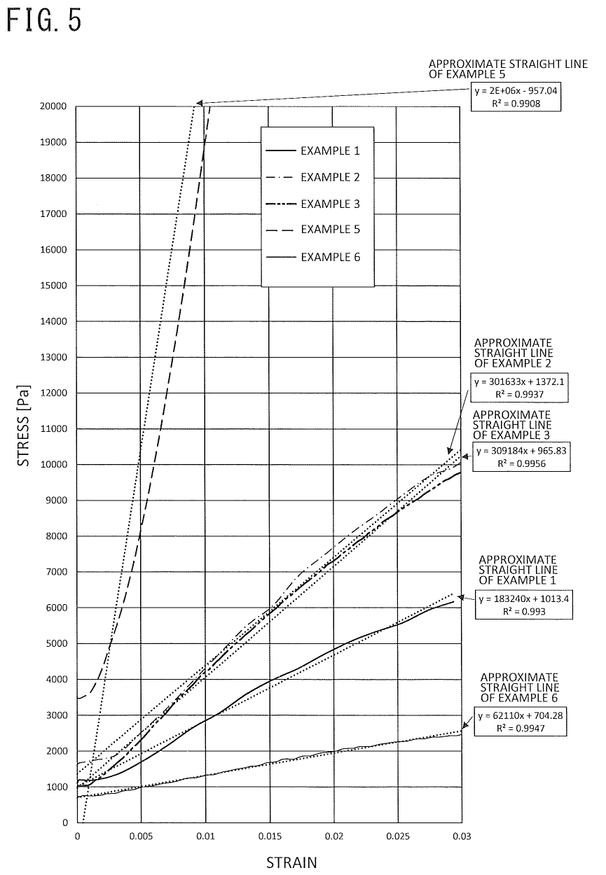

As illustrated in FIG. 4A, it was confirmed that the damping materials for floor of Examples 1 to 3, 5, and 6 each having the polyurethane foam layer 11 significantly improved the damping property (evaluation of damping property was “o” or higher) as compared with Comparative Example 1 made of a nonwoven fabric and Comparative Example 2 of a blank having no damping material for floor. It was also confirmed that the damping materials for floor of Examples 1 to 3 and 6 each having an average elastic modulus of 400 kPa or less in the compressive strain range of 0 to 3% (each of slopes of the approximate straight lines; refer to FIG. 5) were able to exert a particularly excellent damping property as compared with the damping material for floor of Example 5 having an average elastic modulus of more than 400 kPa. In Examples 1 to 8, the compressive strain corresponding to the proportional limit is 3% (0.03) or more in the stress-strain curve (that is, the stress increases linearly with respect to the increase in the strain of at least up to 38; refer to, for example, FIG. 4B).

In Example 6, the evaluation of the damping property was good, but the 25% compressive hardness of the polyurethane foam layer 11 was 10 kPa or less (hardness evaluation was “x”). In contrast, from the results of Examples 1 to 3 and 8, it is found that when the average elastic modulus is 170 kPa or more, the 25% compressive hardness is 13 kPa or more, and thus the hardness is also good in addition to the damping property in the damping material for floor. In Examples 1 to 3, the 50% compressive hardness is from 20 kPa to 50 kPa, inclusive, which is preferable.

As described above, it was confirmed that the damping materials for floor of Example 1 to 3 each having an average elastic modulus of 170 kPa or more and less than 400 kPa exhibited excellent effects in both the damping property against vibrations of 100 to 400 Hz and the hardness.

### Supplementary Note

Hereinafter, feature groups extracted from the above- described embodiment and examples are discussed and the effects or the like are also stated, as necessary.

For example, the following feature group relates to a damping material for floor and a vibration control method, and are considered to be acquired to solve the problem that “a damping function is required for a conventional floor material” in the background art on which “conventionally, various floor materials have been developed (refer to, for example, JP H09-95169 A (Paragraph [0006], FIG. 1, etc.).” In addition, there has been a demand for a novel damping material for floor and a novel vibration control method.

### [Feature 1]

A damping material for floor including a polyurethane foam layer.

With this feature, it is possible to exhibit a damping function by the damping material for floor.

### [Feature 2]

The damping material for floor according to Feature 1, wherein the polyurethane foam layer has an average elastic modulus from 170 kPa to 400 kPa, inclusive, in a compressive strain range of 0 to 3%.

With this feature, it is possible to further enhance the damping property of the damping material for floor. As in the present feature, by setting the average elastic modulus to 170 kPa or more (for example, 180 kPa or more), it is also possible to suppress excessive sinking of the damping material for floor due to compression when the damping material for floor is pressed from above, for example, by being stepped on by a foot.

### [Feature 3]

The damping material for floor according to Feature 1 or 2, further including a fiber layer laminated on the polyurethane foam layer.

### [Feature 4]

The damping material for floor according to any one of Features 1 to 3, for use in an electric vehicle.

### [Feature 5]

The damping material for floor according to any one of Features 1 to 4, configured to control vibrations at 100 to 400 Hz.

### [Feature 6]

The damping material for floor according to any one of Features 1 to 5, wherein the polyurethane foam layer has a 25% compressive hardness from 10 kPa to 30 kPa, inclusive.

With this feature, it is possible to suppress excessive sinking of the damping material for floor due to compression when the damping material for floor is pressed from above, for example, by being stepped on by a foot, and to give the damping material for floor an adequate hardness.

### [Feature 7]

A method for controlling vibrations at 100 to 400 Hz, wherein the damping material for floor according to any one of Features 1 to 6 is placed on a floor surface of a vehicle body.

### [Feature 8]

A floor structure including the damping material for floor according to any one of Features 1 to 6 placed on a floor surface of a vehicle body.

With this feature, it is possible to reduce the vibration of the floor of the vehicle body.

Note that, although specific examples of the techniques included in the claims are disclosed in the present specification and the drawings, the techniques described in the claims are not limited to these specific examples, and includes those obtained by variously modifying and changing the specific examples, and also include those obtained by singly extracting a part from the specific examples.

### DESCRIPTION OF THE REFERENCE NUMERAL

10 Damping material for floor
11 Polyurethane foam layer
20 Fiber layer

1-7. (canceled)

8. A damping material for floor comprising a polyurethane foam layer, wherein the polyurethane foam layer has a 25% compressive hardness from 10 kPa to 30 kPa, inclusive.

9. The damping material for floor according to claim 8, wherein the polyurethane foam layer has an average elastic modulus from 170 kPa to 400 kPa, inclusive, in a compressive strain range of 0 to 3%.

10. The damping material for floor according to claim 8, wherein the polyurethane foam layer has a 50% compressive hardness from 20 kPa to 50 kPa, inclusive.

11. The damping material for floor according to claim 8, wherein the polyurethane foam layer has a 50% compressive hardness from 20 kPa to 50 kPa, inclusive, and
the polyurethane foam layer has an average elastic modulus from 170 kPa to 400 kPa, inclusive, in a compressive strain range of 0 to 3%.

12. The damping material for floor according to claim 8, further comprising a fiber layer laminated on the polyurethane foam layer.

13. The damping material for floor according to claim 8, for use in an electric vehicle.

14. The damping material for floor according to claim 8, configured to control vibrations at 100 to 400 Hz.

15. A method for controlling vibrations at 100 to 400 Hz, wherein the damping material for floor according to claim 8 is placed on a floor surface of a vehicle body.

16. The damping material for floor according to claim 12, wherein an impregnation layer that is impregnated with a raw material of the polyurethane foam layer and is cured is formed in at least a portion of the fiber layer facing the polyurethane foam layer.

17. The method for controlling vibrations according to claim 15, for use on the floor surface of an electric vehicle.
